(19) United States
(12) Patent Application Publication
(10) Pub. No.: US 2019/0036345 A1
(43) Pub. Date: Jan. 31, 2019

(54) METHOD AND ARRANGEMENT FOR PROVIDING ELECTRICAL BALANCING POWER FOR STABILIZING AN ALTERNATING-CURRENT GRID

(71) Applicant: TECHNISCHE WERKE LUDWIGSHAFEN AG, Ludwigshafen (DE)

(72) Inventor: ZOLTAN MESZAROS, LUDWIGSHAFEN (DE)

(21) Appl. No.: 15/659,119

(22) Filed: Jul. 25, 2017

(51) Int. Cl. H02J 3/46; H02J 3/32

(52) U.S. Cl. CPC H02J 3/46; H02J 3/32

(57) ABSTRACT

A method for providing electrical balancing power for stabilizing an alternating-current grid that operates at a preset frequency of, for instance, 50 Hz. A combination unit provides the balancing power. The combination unit is composed of a battery forming an electrical storage device taking in electrical energy from the alternating-current grid or from a generating plant and supplying power to the grid over a first time period. A gas- and/or oil-CHP plant and a generator form an energy producer which, after a start-up phase, delivers energy into the grid over a second period of time. An open-loop and closed-loop controller controls the inflows and outflows of energy within the combination unit in dependence on a grid-control parameter reference value such that the electrical energy supplied to the alternating-current grid by the combination unit or taken from the alternating-current grid by the latter corresponds to the reference value of a balancing energy requisition.

### BACKGROUND OF THE INVENTION

### Field of the Invention

Owing to their structure, alternating-current grids react in a sensitive manner to load fluctuations. For this reason, the fed-in electrical power and the consumed electrical power must always be in equilibrium, since otherwise there are voltage and frequency fluctuations that, in the worst case, can result in damage to the connected electrical equipment. As is known, a difference between fed-in and requisitioned electrical power is compensated by balancing energy output.

The power that is fed in and requisitioned over a long period, however, can only be planned to a certain extent. Thus, for example, in the case of steel production, the energy consumption can be planned long-term, whereas the energy demand of private households fluctuates greatly and cannot be predicted with a high degree of reliability. Likewise, energy production by conventional power plants can be successfully planned; that from renewable-energy power plants, on the other hand, is subject to environmental fluctuations.

The increased use of renewable energy sources in alternating-current grids results in an increased requisition of balancing energy output. Renewable energy sources such a photovoltaic or wind power plants are particularly subject to environmentally determined fluctuations. Thus, on sunny days, photovoltaic plants generate a lot of electrical energy, which can be fed into the alternating-current grid over the day in a manner that can be planned. If fluctuations in the fed-in electrical power then occur in the course of the day, for example because of banks of cloud moving over the solar installations, these fluctuations have to be compensated with balancing energy output, by so-called balancing energy requisitions.

The balancing energy output is generated by electricity generators that can be connected-in and disconnected, or also electricity consumers. In this case, if more electrical power is requisitioned from the alternating-current grid than is fed in at a given point in time, initially rapid-start electricity generators, which provide so-called primary balancing power, are started up for short-time balancing. If this disequilibrium cannot be covered by the primary balancing power alone, because the requisitioned power is required over several minutes, generators and power plants that can provide their balancing power after only approximately five minutes are powered-up. This is the so-called secondary balancing power. If the required energy is needed over a longer period, further power plants, which have a longer start-up phase, for example a start-up phase of 15 minutes or more, are powered-up. The latter form the so-called minute reserve or tertiary balancing power, which can be provided over a period of any duration and thereby result in an increase in the power level within the alternating-current grid.

Usually, in the past, conventional gas and/or oil cogeneration, or combined heat and power, plants, referred to as “CHP plants” in the following, which comprise, for example, gas, oil or gas-and-oil turbines for providing the power, were used in the minute reserve sector. Owing to the increased prices for fossil fuels and the excess of alternatively generated electrical energy on the electricity market, for some years now it has no longer been economic for these plants to be operated for sustained electricity generation. Moreover, owing to the long start-up time, of over five minutes from standstill, these turbines cannot easily be prequalified for the secondary balancing energy market. Although standby operation, in which the turbines continuously run concomitantly at reduced power and service a positive secondary balancing energy requisition, is technically possible, it is not expedient economically or from environmental aspects. Consequently, these turbines are frequently at a standstill.

The primary balancing power may be provided, for example, by battery-storage power plants, which can generate negative and positive balancing power short-term, within a few seconds. Owing to the required minimum power and capacity, however, battery-storage power plants are not economical for the secondary balancing energy sector, since the amount of energy to be delivered requires a multiplicity of expensive battery modules.

### SUMMARY OF THE INVENTION

It is accordingly an object of the invention to provide a method for providing electrical balancing power for stabilizing an alternating-current grid which overcomes the above-mentioned and other disadvantages of the heretofore-known devices and methods of this general type and that makes it possible to minimize the capacity of a battery storage, in a combination, operated as a unit, that is composed of a battery storage and a gas- and/or oil-CHP plant, i.e. a cogeneration plant in which the power is provided by an oil and/or gas turbine.

With the foregoing and other objects in view there is provided, in accordance with the invention, a method for providing electrical balancing power for stabilizing an alternating-current grid operating at a preset frequency, the method which comprises:

providing a combination unit for providing electrical balancing power, wherein the combination unit includes:
an energy producer configured to deliver, after a start-up phase, energy into the alternating-current grid over a second period of time, the energy producer being a gas- and/or oil-CHP plant that, via a generator driven by the gas- and/or oil-CHP plant, feeds electrical energy into the alternating-current grid;
an electrical storage device configured to receive electrical energy from the alternating-current grid or from the energy producer and to deliver electrical energy into the alternating-current grid over a first period of time, the energy storage device being a battery, which is connected to the electrical alternating-current grid via an inverter and a rectifier;

controlling the combination unit with an open-loop and closed-loop controller by adjusting inflows and outflows of energy within the combination unit in dependence on a grid-control parameter reference value and by adjusting an electrical energy supplied to the alternating-current grid or taken from the alternating-current grid to the reference value of a balancing energy requisition, in particular a secondary balancing energy requisition;

the open-loop and closed-loop control means being electrically coupled to the gas- and/or oil-CHP plant, to the generator, to the inverter and to the rectifier, and configured to control same by open-loop and closed-loop control to cause the combination unit to adhere to the grid-control parameter reference values (e.g., power level, power gradient, voltage level, frequency).

using the open-loop and closed-loop controller to feed electrical energy from the battery, via the inverter, into the alternating-current grid, and substantially simultaneously starting the gas- and/or oil-CHP plant and reducing a power of the battery being fed into the alternating-current grid by an amount to which the electrical power fed into the alternating-current grid from the gas- and/or oil-CHP plant and the generator is increased.

It is a further object of the invention to provide for an arrangement for executing the method, by means of which, with use of a battery storage of minimal capacity, electrical balancing power can be provided within a very short time in a highly dynamic manner, over a period of time that, in principle, may be of any duration.

With the foregoing and other objects in view there is provided, in accordance with the invention, an arrangement for executing the above-summarized method for providing electrical balancing power for stabilizing an alternating-current grid that operates at a preset frequency of, in particular 50 Hz. The novel arrangement comprises:

a combination unit for providing electrical balancing power, the combination unit including:

an energy producer being a gas- and/or oil-CHP plant and a generator driven by the gas- and/or oil-CHP plant, for feeding electrical energy into the alternating-current grid;

an energy storage device being a battery connected to the electrical alternating-current grid via an inverter and a rectifier, said storage device being configured to take up electrical energy from the alternating-current grid or from said energy producer and to deliver electrical energy to said energy producer over a first period of time;

said energy producer, after a start-up phase, delivering energy into the alternating-current grid over a second period of time;

an open-loop and closed-loop controller assigned to said combination unit, said controller controlling inflows and outflows of energy of said combination unit in dependence on a grid-control parameter reference value such that an electrical energy supplied to the alternating-current grid by the combination unit or taken from the alternating-current grid by the combination unit corresponds to the reference value of a balancing energy requisition;
wherein said open-loop and closed-loop controller is electrically connected to said gas- and/or oil-CHP plant, to said generator, to said inverter and to said rectifier, and is configured to control same by open-loop and closed-loop control such that the electrical power that is fed into the alternating-current grid from the battery via the inverter is reduced, in dependence on an currently requested grid-control parameter reference value, by an extent to which the electrical power fed into the alternating-current grid from the gas- and/or oil-CHP plant and the generator is increased following a starting-up of the gas- and/or oil-CHP plant.

According to the method according to the invention for providing electrical balancing power for stabilizing an alternating-current grid that operates at a preset frequency of, in particular 50 Hz, provided for the purpose of providing electrical balancing power there is a combination unit, which includes an electrical energy storage device (“energy storage” for short), which can take up electrical energy from the alternating-current grid or from a generating plant and deliver electrical energy into the latter over a first period of time, and an energy producer that, after a start-up phase, can deliver energy into the alternating-current grid over a second period of time.

Furthermore, assigned to the combination unit there is an open-loop and closed-loop control means, which controls the inflows and outflows of energy within the combination unit in dependence on a grid-control parameter reference value. This control is effected such that the electrical energy supplied to the alternating-current grid by the combination unit or taken from the alternating-current grid by the latter corresponds to the reference value of a balancing energy requisition. The balancing energy requisition is a value supplied externally to the combination unit, or a requisition of electrical power, such as, for example, a requisition of primary balancing power, secondary balancing power, tertiary balancing power, or a combination of the aforementioned balancing energy output requisitions, that is caused by the alternating-current grid.

The method according to the invention is characterized in that the energy producer is a gas- and/or oil-CHP plant that, via a generator driven by the latter, feeds the electrical energy into the alternating-current grid. The energy storage is a battery, for example a lithium polymer battery, which is connected to the electrical alternating-current grid via an inverter and a rectifier. The open-loop and closed-loop control means is electrically coupled to the gas- and/or oil-CHP plant, the generator, the inverter and the rectifier, and controls these by open-loop and closed-loop control such that the combination unit adheres to the grid-control parameter reference values, in particular the power level, the power gradient, the voltage level and the frequency. In this case, electrical energy is fed into the alternating-current grid from the battery, via the inverter, by the open-loop and closed-loop control means, and the gas- and/or oil-CHP plant is started substantially simultaneously. According to the invention, in this case the electrical power of the battery that is fed into the alternating-current grid is reduced, as the gas- and/or oil-CHP plant is powered-up, by the extent to which the electrical power fed into the alternating-current grid by the gas- and/or oil-CHP plant and the generator is increased. In this case the duration for powering-up the gas- and/or oil-CHP plant is determined primarily by the powering-up of the turbine used therein.

The invention offers the advantages that a slow-response gas- and/or oil-CHP plant that, because of its comparatively long power-up time of more than five minutes, does not on its own prequalify for the provision of secondary balancing power, can now, as a result of being combined with a battery storage, which only has a comparatively small capacity that, likewise, on its own is not sufficient for providing secondary balancing power, be operated as a highly dynamic unit that inexpensively combines the advantages of both systems and -except for the necessary servicing works—can in principle be operated, if required, for a time period of any duration.

The method according to the invention is particularly suitable for retrofitting in the case of already installed turbines that, owing to the increased fuel prices, can no longer be operated economically at present and consequently, without the method according to the invention, would be obsolete. The use of the method according to the invention now enables these currently unused CHP plants or, generally, the gas and/or oil turbines used in combination with generators, to be reactivated, with a comparatively manageable financial investment expenditure, to provide primary and secondary balancing power, which is of increasing importance for reliable operation of the electricity grids, in particular in the case of a further increase in the proportion of renewable power sources.

In the case of the preferred embodiment of the invention, the energy storage provides the required electrical energy for starting the gas- and/or oil-CHP plant during the start-up phase.

This has the resultant advantage that the combination unit can be started without electrical power flowing out of the alternating-current grid. This starting of operation of the combination unit, referred to as cold-start capability, has the advantage that, in the case of a power requisition, it is not necessary for yet more electrical power to be taken from the already loaded alternating-current grid for the starting operation of the turbine.

In the case of the preferred embodiment of the invention, after a balancing power requisition, following the second period, for the purpose of charging the battery the open-loop and closed-loop control means continues to activate the rectifier, as well the gas- and/or oil-CHP plant and the generator, for such a period of time until the quantity of energy taken from the battery during the starting operation and the start-up phase has been put back into the battery.

Advantageously, in the case of application of the method according to the invention, the energy storage is operated on a middle charge level, preferably at 40% to 60% of its nominal capacity, in order to be able to provide both positive balancing power, i.e. the delivery of electrical energy from the storage into the alternating-current grid, and negative balancing power, i.e. outflow of electrical energy out of the alternating-current grid into the storage.

According to another of the concepts on which the invention is based, the battery has a nominal power such that it can simultaneously provide, over the first period of time, primary balancing power, secondary balancing power and the required electrical power for starting the turbine.

Although the costs for the battery storage are thereby increased, this has the advantage that the combination unit can simultaneously service a request for primary balancing power and a request for secondary balancing power.

According to a further embodiment of the invention, if no negative balancing power request is being serviced by the combination unit, i.e. electrical power being taken from the electricity network, the charging of the battery is effected by the generator driven by the gas- and/or oil-CHP plant, via the rectifier, without additional electrical power being taken out of the alternating-current grid for this purpose. This has the resultant advantage that the turbine of the CHP plant is operated for a longer duration, and consequently, if necessary, is again available for a request for secondary balancing power that comes in during the charging operation, without shut-down of the turbine in the interim.

Furthermore, in the case of the previously described embodiments, the amount of energy that the battery can deliver or receive is preferably less than the quantity of energy of a secondary balancing power request of maximum duration. As a result, the size—and consequently the costs—for the provision of the battery storage can be reduced considerably, while maintaining the advantages associated with the invention.

According to another of the concepts on which the invention is based, an arrangement according to the invention for executing the previously described method for providing electrical balancing power for stabilizing an alternating-current grid that operates at a preset frequency of, in particular 50 Hz, comprises a combination unit for providing electrical balancing power. The combination unit comprises an energy storage that can take up electrical energy from the alternating-current grid or from another known generating plant and deliver electrical energy into the latter over a first period of time, and an energy producer that, after a start-up phase, can deliver energy into the alternating-current grid over a second period of time. Furthermore, assigned to the combination unit there is an open-loop and closed-loop control means, which controls the inflows and outflows of energy within the combination unit in dependence on a grid-control parameter reference value. The open-loop and closed-loop control means in this case controls, by open-loop and closed-loop control, the electrical energy supplied to the alternating-current grid by the combination unit or taken from the alternating-current grid by the latter in such a manner that this electrical energy corresponds to the reference value of a balancing energy requisition, in particular a secondary balancing energy requisition.

According to the invention, the energy producer in this case is a gas- and/or oil-CHP plant that, via a generator driven by the latter, feeds electrical energy into the alternating-current grid. The energy storage comprises a battery, which is connected to the electrical alternating-current grid via an inverter and a rectifier. The open-loop and closed-loop control means is electrically coupled to the gas- and/or oil-CHP plant, the generator, the inverter and the rectifier, and controls the aforementioned components by open-loop or closed-loop control such that the electrical power that is fed into the alternating-current grid by the battery via the inverter is reduced, in dependence on an currently requested balancing energy requisition, by the extent to which the electrical power fed into the alternating-current grid by the gas- and/or oil-CHP plant and the generator is increased following the starting-up of the turbine. The balancing energy requisition in this case may be an energy requisition for primary balancing power and/or secondary balancing power and/or, also, for so-called minute reserve.

In the case of the preferred embodiment of the arrangement according to the invention, the energy producer has a nominal electrical power of 1 MW to 25 MW, preferably 2 MW to 15 MW, particularly preferably 5 MW. The operating voltage of the alternating-current grid in this case is preferably in the range of 10 kV to 30 kV, preferably 15 kV to 25 kV, particularly preferably 20 kV.

According to another of the concepts on which the invention is based, the energy storage has an electrical capacity of 1 to 25 MWh, preferably 2 to 15 MWh, particularly preferably 4 MWh to 7 MWh. The electrical capacity of the energy storage in this case is advantageously selected in dependence on the nominal electrical power of the energy producer, or on the corresponding nominal power for the prequalification of the combination unit, such that at least one primary balancing power requisition and one secondary balancing power requisition can be serviced simultaneously.

In the case of a particularly preferred embodiment of the invention, the inverter has a nominal electrical power that corresponds at least to the sum of a maximum electrical primary balancing power, maximum secondary balancing power and the electrical starting power required for the starting operation of the gas- and/or oil-CHP plant.

This offers the advantage that the combination unit has cold-start capability.

According to another of the concepts on which the invention is based, the rectifier and/or the inverter are/is integrated into the combination unit. This has the advantage that the combination unit can be of a more compact structure.

In the case of the preferred embodiment of the invention, the capacity of the battery is selected such that the requested balancing power can be made available immediately, and the powering-up period of the gas- and/or oil-CHP plant can be bypassed.

According to another of the concepts on which the invention is based, it is particularly advantageous, in respect of a high dynamic of the combination unit, if the open-loop and closed-loop control means controls the energy inflows and outflows within the combination unit by short-term connecting-in and disconnection of the battery, via the inverter or the rectifier, with the gas- and/or oil-CHP plant switched on. In this case, the energy that the gas- and/or oil-CHP plant, for example within the combination unit, is consumed by the battery, for charging the latter, whereas outwardly, i.e. in respect of the electricity grid, only the cumulated power, composed of positive electrical power of the gas- and/or oil-CHP plant and negative power of the battery, is provided.

This has the advantage that the gas- and/or oil-CHP plant, or the turbine used therein that is comparatively slow in powering-up and has a slow response to changes in the electrical power required during continuous operation, acts outwardly in a considerably more dynamic manner, by which it only becomes possible at all to service both positive and negative short-term primary balancing power requests in the required time and, at the same time, also to service secondary balancing power requests.

According to another of the concepts on which the invention is based, the rectifier may be integrally integrated as a unit into the inverter. The rectifier in this case is able to charge the battery, for which purpose the rectifier may have, for example, a charge regulator integrated into the rectifier, or the energy storage is coupled to the rectifier via a suitable electronic battery management system.

Once more in summary, there is provided, a method for providing electrical balancing power for stabilizing an alternating-current grid 2 that operates at a preset frequency of, in particular 50 Hz, wherein provided for the purpose of providing electrical balancing power there is a combination unit 4, which is composed of an electrical storage device 6, which can take up electrical energy from the alternating-current grid 2 or from a generating plant and deliver electrical energy into the latter over a first period of time, and of an energy producer 8 that, after a start-up phase, can deliver energy into the alternating-current grid 2 over a second period of time, and assigned to the combination unit 4 there is an open-loop and closed-loop control means 10, which controls the inflows and outflows of energy within the combination unit 4 in dependence on a grid-control parameter reference value 12 such that the electrical energy supplied to the alternating-current grid 2 by the combination unit 4 or taken from the alternating-current grid 2 by the latter corresponds to the reference value of a balancing energy requisition 12, in particular a secondary balancing energy requisition, is characterized in that the energy producer 8 is a gas- and/or oil-CHP plant that, via a generator 14 driven by the latter, feeds electrical energy into the alternating-current grid 2, the energy storage device 6 is a battery, which is connected to the electrical alternating-current grid 2 via an inverter 16 and a rectifier 18, and the open-loop and closed-loop control means 10 is electrically coupled to the gas- and/or oil-CHP plant 8, the generator 14, the inverter 16 and the rectifier 18, and controls these by open-loop and closed-loop control such that the combination unit 4 adheres to the grid-control parameter reference values 12, in particular the power level, the power gradient, the voltage level and the frequency, in that the open-loop and closed-loop control means 10 feeds electrical energy into the alternating-current grid 2 from the battery 6, via the inverter 16, and starts the gas- and/or oil-CHP plant 8 substantially simultaneously, wherein the power of the battery 6 that is fed into the alternating-current grid 2 is reduced by the extent to which the electrical power fed into the alternating-current grid 2 by the gas- and/or oil-CHP plant 8 and the generator 14 is increased.

Other features which are considered as characteristic for the invention are set forth in the appended claims.

Although the invention is illustrated and described herein as embodied in a method and arrangement for providing electrical balancing power for stabilizing an alternating-current grid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 a schematic representation of an arrangement according to the invention for providing electrical balancing power for stabilizing an alternating-current grid;

FIG. 2 a schematic representation of the arrangement according to the invention in the case of delivery of electrical balancing power by the energy storage;

FIG. 3 a schematic representation of the arrangement according to the invention in the case of delivery of electrical balancing power by a combination of energy storage and energy producer;

FIG. 4 a schematic representation of the arrangement according to the invention in the case of delivery of electrical balancing power and the simultaneous recharging of the energy storage by the energy producer;

FIG. 5 a schematic representation of the arrangement according to the invention in the case of delivery of electrical balancing power by the energy producer;

FIG. 6 a schematic representation of the arrangement according to the invention in the case of charging of the energy storage by the energy producer without delivery of electrical balancing power;

FIG. 7 a schematic representation of the arrangement according to the invention in the case of take-up of electrical balancing power by the energy storage; and

FIG. 8 a schematic power diagram of the combination unit for the simultaneous delivery of primary and secondary balancing power.

### DETAILED DESCRIPTION OF THE INVENTION

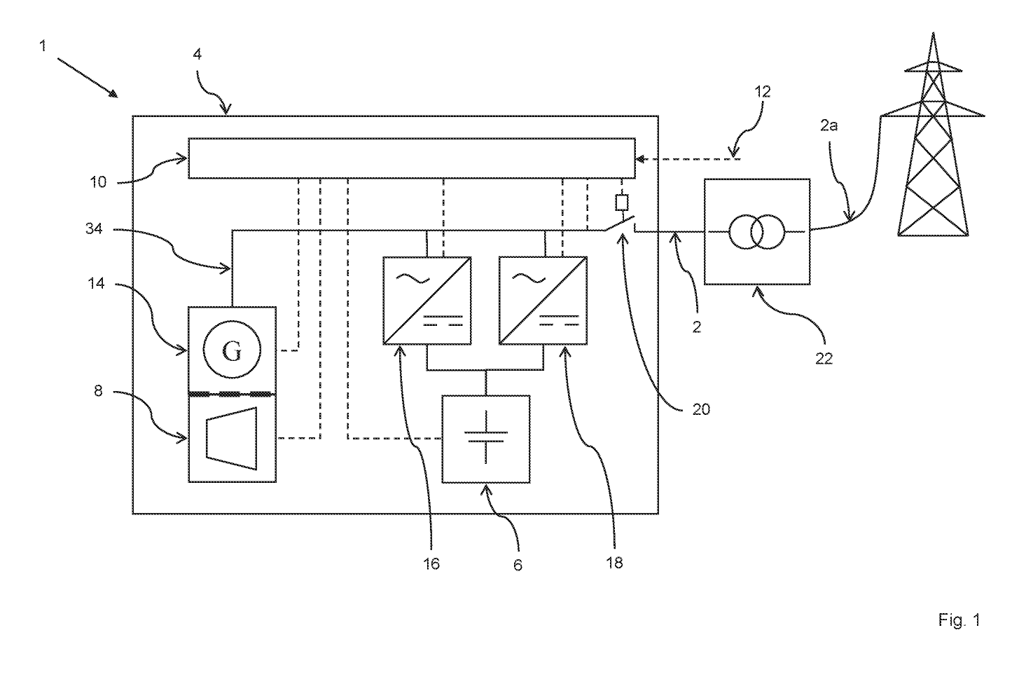

Referring now to the figures of the drawing in detail and first, particularly, to FIG. 1 thereof, there is shown an arrangement 1 according to the invention for providing electrical balancing power for stabilizing an alternating-current grid 2 in the form of a combination unit 4. The alternating-current grid 2, which advantageously is designed as a medium-voltage grid having an operating voltage of 3 kV to 30 kV, in particular 20 kV, is preferably connected, via a transformer 22, to a high-voltage grid 2a, by which the electricity is carried over large distances. The high-voltage grid is operated, for example, at voltages of from 60 kV up to 1150 kV, preferably 110 kV.

The combination unit 4 comprises an energy storage in the form of a battery storage 6, an inverter 16, a rectifier or charge regulator 18, an energy producer 8 and a generator 14. In this case, the energy storage 6 can take up electrical energy from the alternating-current grid 2, or alternatively from another known generating plant, e.g. a diesel generator set, via the rectifier 18, and at a later point in time deliver this energy to the alternating-current grid 2, via the inverter 16, over a first period of time. After a start-up phase, the energy producer 8 can deliver electrical energy into the alternating-current grid 2, by means of the generator 14, over a second period of time.

The alternating-current grid 2 in this case is operated at a substantially constant preset frequency of, in particular, 50 Hz, which is stabilized by supplied or extracted balancing energy.

The combination unit 4 comprises an open-loop and closed-loop controller 10, which controls the inflows and outflows of energy within the combination unit 4 in dependence on a grid-control parameter reference value 12.

According to the invention, the energy producer 8 is a gas- and/or oil-CHP plant 8, which is coupled to the driven generator 14 and, via the latter, can feed the electrical energy into the alternating-current grid 2. The energy storage 6 is a battery storage having a multiplicity of, in particular, lithium batteries such as, for example, lithium polymer batteries, which is connected, via the inverter 16 and the rectifier 18, to the electrical alternating-current grid 2. The open-loop and closed-loop control means 10 in this case is electrically coupled to the gas- and/or oil-CHP plant 8, the generator 14, the inverter 16 and the rectifier 18.

As is additionally shown in FIG. 1, the combination unit 4 preferably has a grid disconnect switch 20, by means of which a busbar 34 can be connected to or disconnected from the alternating-current grid 2, connected to which busbar is the open-loop and closed-loop control means 10, which detects and processes the instantaneous currents and voltages on the busbar 34.

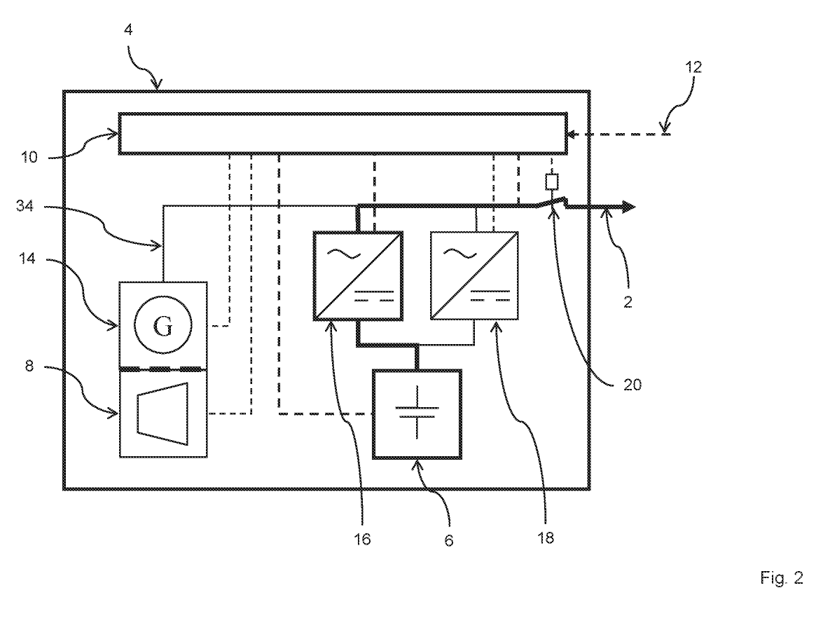

FIG. 2 shows a requisition of balancing power by the combination unit 4 following the receipt of a grid-control parameter reference value 12. The grid-control parameter reference value 12 supplied, for example, via a data network, not shown in greater detail, that is detected and processed by the open-loop and closed-loop control means 10. The latter derives therefrom a quantity for the balancing energy to be provided and, by controlling the inverter 16 accordingly, provides this balancing energy from the energy storage 6, which balancing energy is supplied to the alternating-current grid 2 by closing of the grid disconnect switch 20.

Depending on the requested power and the duration of the balancing energy requisition, and on the current charge state of the battery 6, it is decided by the open-loop and closed-loop control means 10 whether or not the gas- and/or oil-CHP plant 8 is powered-up. If differing balancing energy requisitions come in simultaneously, such as, for example, a simultaneous requisition of primary balancing energy and secondary balancing energy, the CHP plant 8, or the turbine used therein, is preferably powered-up substantially simultaneously with the receipt of the power request by the grid-control parameter reference value 12.

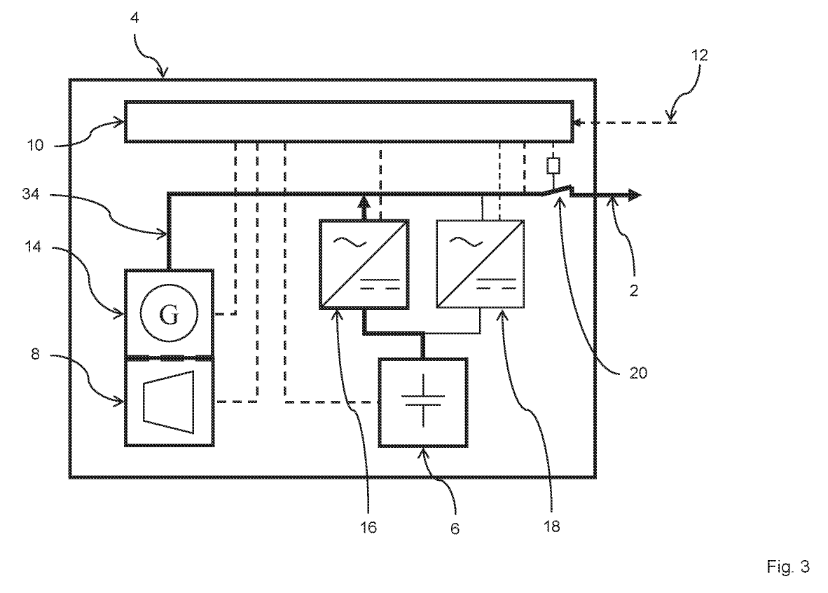

FIG. 3 shows the requisition of positive secondary balancing energy and the possibly simultaneous requisition of positive primary balancing energy. The request by the grid-control parameter reference value 12 in this case causes the open-loop and closed-loop control means 10 to activate the inverter 16, in order to provide the required primary balancing power via the battery 6. The gas- and/or oil-CHP plant 8 is started substantially simultaneously. For this purpose, preferably, excess energy is used, which is provided, for example, via the alternating-current grid 2, on the busbar 34. Should there be no additional energy available from the alternating-current grid 2 for starting the turbine, the inverter 16 is controlled by the open-loop and closed-loop control means 10 in such a manner that the starting energy that is required in addition to the primary balancing power request is provided by the battery 6. Following the starting of the turbine 14 and during the powering-up of the latter, the electrical power delivered by the battery 6 is continuously reduced by the open-loop and closed-loop control means 10, by corresponding control of the inverter 16, by the amount of the electrical power provided by the gas- and/or oil-CHP plant 8 via the generator 14. For this purpose, the open-loop and closed-loop control means 10 preferably continuously compares the electrical power provided on the busbar 34 with the balancing power requested by the grid-control parameter reference value 12.

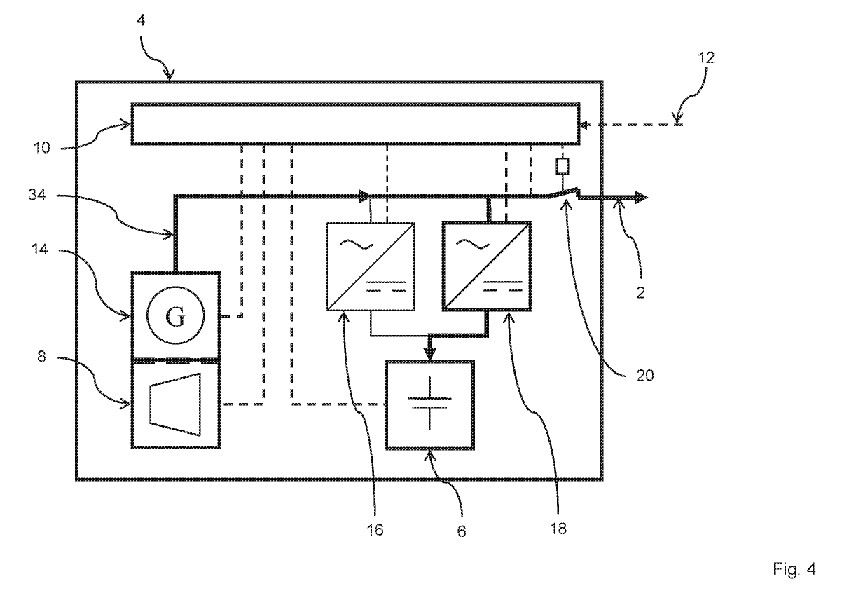

In FIG. 4, the battery 6 is being charged, via the rectifier 18, with the electrical power provided on the busbar 34 by the gas- and/or oil-CHP plant 8 via the driven generator 14, while balancing power is simultaneously being delivered to the alternating-current grid 2.

The gas- and/or oil-CHP plant 8 is advantageously dimensioned such that, even during a secondary balancing energy requisition of greatest possible magnitude, it can still additionally provide electrical power that, in this case, is preferably used to chare the battery 6. This enables the energy provider/battery 6 to be kept to a preferably medium charge state, of approximately 50% to 60% of its nominal capacity, even if a plurality of primary balancing energy requisitions have to be serviced multiple times in rapid succession, in addition to a secondary balancing energy requisition.

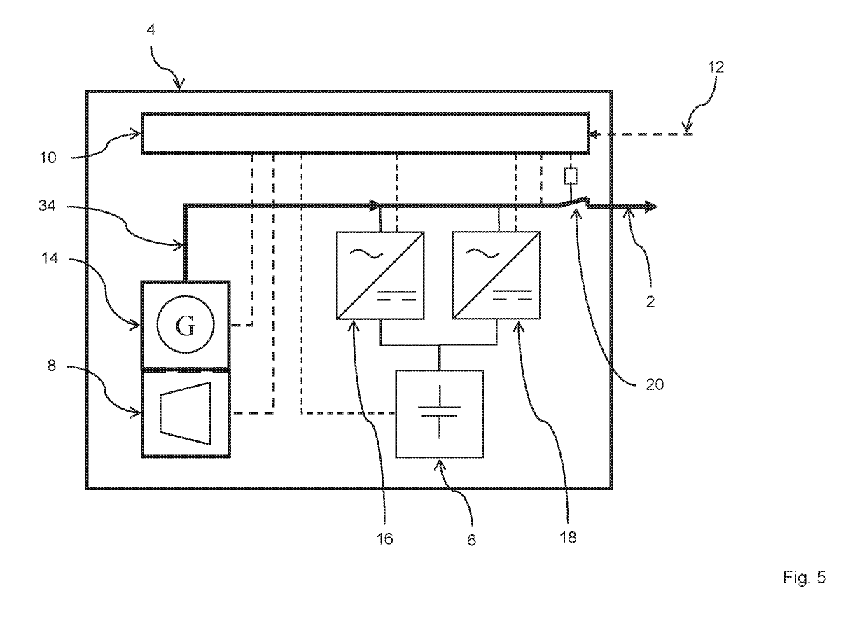

In the configuration shown in FIG. 5, the combination unit 4 provides balancing power exclusively via the gas- and/or oil-CHP plant 8, while the battery 6, the inverter 16 and the rectifier 18 are not activated. In this configuration, the combination unit 4 can provide balancing power over a very long period of time, for example several hours or, in exceptional cases, even several days, if this should be necessary, for example, because of a failure of a main power generator in the alternating-current grid 2.

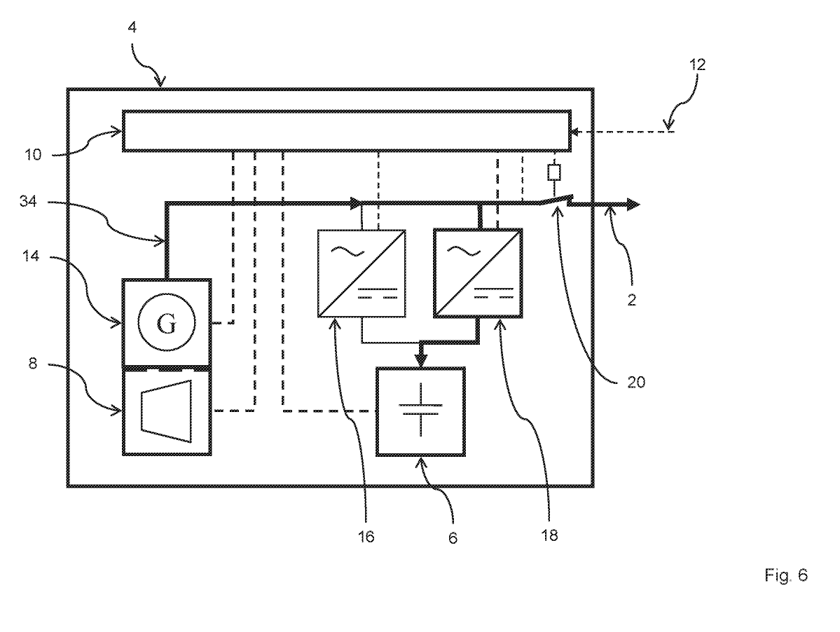

FIG. 6 shows the charging of the battery 6 by the gas- and/or oil-CHP plant 8. The power of the generated energy corresponds to the charging power of the battery 6. This has the resultant advantage that the battery 6, following the completion of a balancing energy requisition by the running gas- and/or oil-CHP plant 8, can be recharged without extracting energy from the alternating-current grid 2.

It is likewise conceivable or the gas- and/or oil-CHP plant 8, upon attainment of a threshold value for the charge state of the battery 6, e.g. in the case of a residual energy quantity that corresponds only to 20% of the nominal capacity, to be started by the open-loop and closed-loop control means 10, in order to charge the battery 6 independently of the alternating-current grid 2.

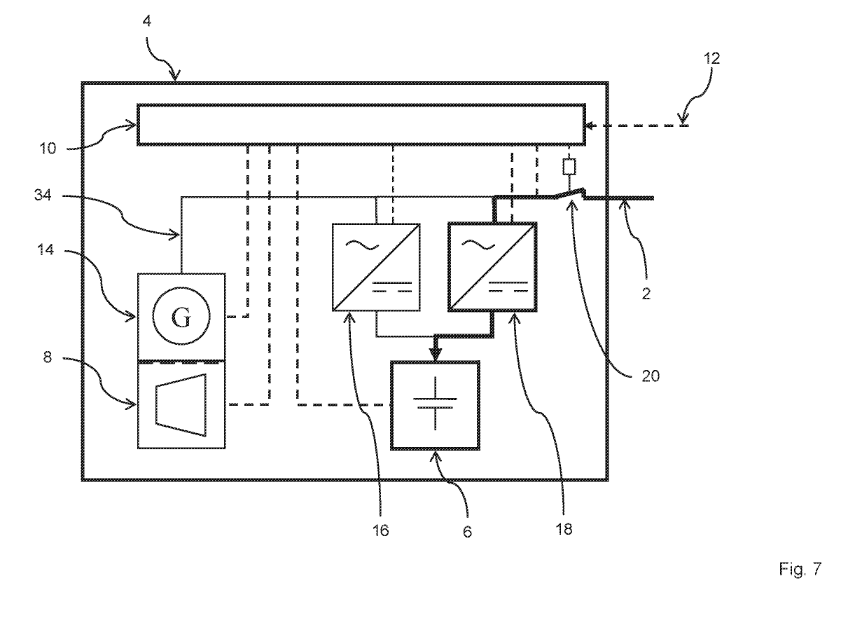

FIG. 7 shows the take-up of negative electrical balancing power by the combination unit 4. The balancing energy request by the grid-control parameter reference value 12 in this case is processed by the open-loop and closed-loop control means 10. The latter activates the rectifier 18. As a result, electrical energy from the alternating-current grid 2 is put into the battery 6, via the busbar 34, by the rectifier 18.

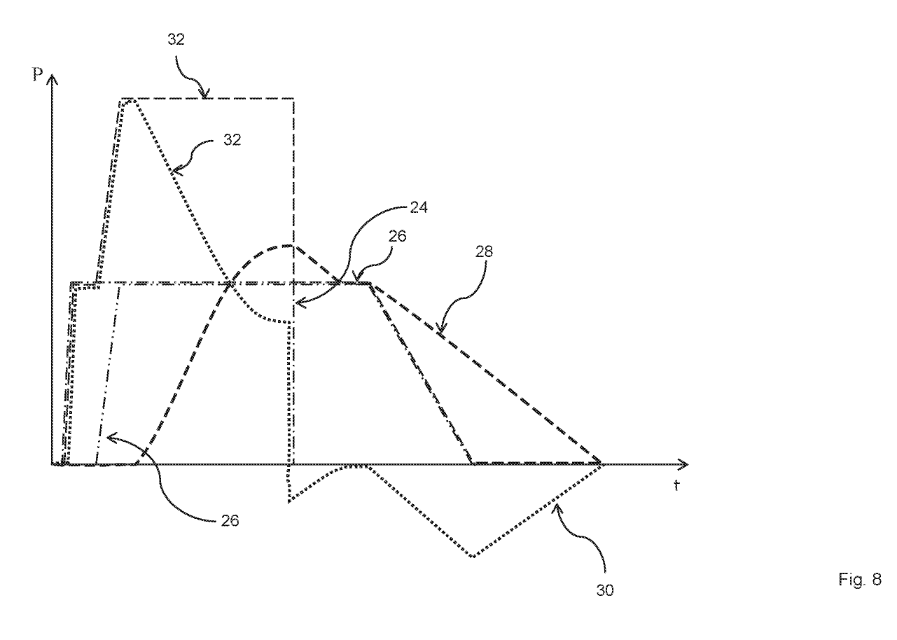

Shown exemplarily in FIG. 8 is a virtually simultaneous requisition of primary and secondary balancing power. Here, the time is plotted on the abscissa, and the electrical power P is plotted on the ordinate. In this case, the curve 24 represented as a dot-dashed line indicates the requisition of primary balancing energy, following the rise of which the open-loop and closed-loop control means 10, in a manner similar to FIG. 2, provides primary balancing power, in the form of the power curve 32, through the combination unit 4. Following the attainment of the required balancing power, in the example of FIG. 8 there is a further requisition of balancing power, in the form of a secondary balancing energy requisition 26. This results in the gas- and/or oil-CHP plant 8 being started up and, after the reference rotational speed has been attained, the electrical power represented by the curve 26 is increased continuously by the generator 14. In this case, the power 30 provided by the energy storage/battery 6 is reduced to the same extent by the open-loop and closed-loop control means 10, by corresponding control of the inverter 16. In this case, the electrical power 32 delivered to the alternating-current grid 2 by the combination unit 4 is substantially constant at the required plateau. Owing to the power reserves of the gas- and/or oil-CHP plant 8, the latter, following start-up, assumes an ever greater proportion of the provided electrical power 32 of the combination unit 4, up to the end of the primary balancing energy requisition 24. After the primary balancing energy requisition 24 has ended, the gas- and/or oil-CHP plant 8 is powered-down in a controlled manner to the lowered plateau for the secondary balancing energy requisition 26. In order to achieve the plateau as rapidly as possible, the excess power of the turbine 8 in this case is preferably used for charging the battery 6, in a manner similar to the configuration shown in FIG. 4. Following the completion of the remaining secondary balancing energy requisition 26 and the stepped powering-down, the combination unit 4 is first operated, in a manner similar to the configuration of FIG. 4, until no more balancing energy output is requisitioned. Then, in a manner similar to the configuration of FIG. 6, the energy storage/battery 6 is charged again by the started gas- and/or oil-CHP plant 8.

The following is a summary list of reference numerals and the corresponding structure used in the above description of the invention:
1 arrangement according to the invention
2 alternating-current grid
4 combination unit
6 energy storage
8 energy producer
10 open-loop and closed-loop control means
12 grid-control parameter reference value
14 generator
16 inverter
18 rectifier
20 grid disconnect switch
22 transformer
24 primary balancing energy requisition
26 secondary balancing energy requisition
28 power curve, gas turbine
30 power curve, battery
32 power curve, combination unit
34 busbar

1. A method for providing electrical balancing power for stabilizing an alternating-current grid operating at a preset frequency, the method which comprises:
providing a combination unit for providing electrical balancing power, wherein the combination unit includes:
an energy producer configured to deliver, after a start-up phase, energy into the alternating-current grid over a second period of time, the energy producer being a gas- and/or oil-CHP plant that, via a generator driven by the gas- and/or oil-CHP plant, feeds electrical energy into the alternating-current grid;
an electrical storage device configured to receive electrical energy from the alternating-current grid or from the energy producer and to deliver electrical energy into the alternating-current grid over a first period of time, the energy storage device being a battery, which is connected to the electrical alternating-current grid via an inverter and a rectifier;
controlling the combination unit with an open-loop and closed-loop controller by adjusting inflows and outflows of energy within the combination unit in dependence on a grid-control parameter reference value and by adjusting an electrical energy supplied to the alternating-current grid or taken from the alternating-current grid to the reference value of a balancing energy requisition;
the open-loop and closed-loop control means being electrically coupled to the gas- and/or oil-CHP plant, to the generator, to the inverter and to the rectifier, and configured to control same by open-loop and closed-loop control to cause the combination unit to adhere to the grid-control parameter reference values;
using the open-loop and closed-loop controller to feed electrical energy from the battery, via the inverter, into the alternating-current grid, and substantially simultaneously starting the gas- and/or oil-CHP plant and reducing a power of the battery being fed into the alternating-current grid by an amount to which the electrical power fed into the alternating-current grid from the gas- and/or oil-CHP plant and the generator is increased.

2. The method according to claim 1, wherein the reference value of the balancing energy requisition is a secondary balancing energy requisition, and the grid-control parameter reference values are a power level, a power gradient, a voltage level and a frequency.

3. The method according to claim 1, which comprises providing required electrical energy for starting the gas- and/or oil-CHP plant during the start-up phase from the energy storage device.

4. The method according to claim 1, which comprises, after a balancing power requisition and following the second period, charging the battery by continued activation of the rectifier and of the gas- and/or oil-CHP plant and the generator for such a period of time until a quantity of energy taken from the battery during the starting operation and the start-up phase has been fed back into the battery.

5. The method according to claim 1, wherein the battery has a nominal power enabling the batter to simultaneously provide, over the first period of time, primary balancing power, secondary balancing power and the electrical power required for starting the gas- and/or oil-CHP plant.

6. The method according to claim 4, which comprises charging the battery with power from the generator driven by the gas- and/or oil-CHP plant and through the rectifier, without additional electrical power being taken from the alternating-current grid.

7. The method according to claim 4, wherein an amount of energy that the battery can deliver or receive is less than an amount of energy of a secondary balancing power request of maximum duration.

8. An arrangement for executing the method according to claim 1, for providing electrical balancing power for stabilizing an alternating-current grid that operates at a preset frequency of, in particular 50 Hz, the arrangement comprising:
a combination unit for providing electrical balancing power, the combination unit including:
an energy producer being a gas- and/or oil-CHP plant and a generator driven by the gas- and/or oil-CHP plant, for feeding electrical energy into the alternating-current grid;
an energy storage device being a battery connected to the electrical alternating-current grid via an inverter and a rectifier, said storage device being configured to take up electrical energy from the alternating-current grid or from said energy producer and to deliver electrical energy to said energy producer over a first period of time;
said energy producer, after a start-up phase, delivering energy into the alternating-current grid over a second period of time;
an open-loop and closed-loop controller assigned to said combination unit, said controller controlling inflows and outflows of energy of said combination unit in dependence on a grid-control parameter reference value such that an electrical energy supplied to the alternating-current grid by the combination unit or taken from the alternating-current grid by the combination unit corresponds to the reference value of a balancing energy requisition;
wherein said open-loop and closed-loop controller is electrically connected to said gas- and/or oil-CHP plant, to said generator, to said inverter and to said rectifier, and is configured to control same by open-loop and closed-loop control such that the electrical power that is fed into the alternating-current grid from the battery via the inverter is reduced, in dependence on an currently requested grid-control parameter reference value, by an extent to which the electrical power fed into the alternating-current grid from the gas- and/or oil-CHP plant and the generator is increased following a starting-up of the gas- and/or oil-CHP plant.

9. The arrangement according to claim 8, wherein the open-loop and closed-loop controller is configured to control the energy flow from the battery in accordance with a requisitioned secondary balancing power, or a requisitioned minute reserve.

10. The arrangement according to claim 8, wherein said energy producer has a nominal electrical power of between 1 MW and 25 MW.

11. The arrangement according to claim 10, wherein said energy producer has a nominal electrical power of between 2 MW and 15 MW.

12. The arrangement according to claim 11, wherein said energy producer has a nominal electrical power of 5 MW.

13. The arrangement according to claim 8, wherein said energy storage device has an electrical capacity of between 1 MWh and 25 MWh.

14. The arrangement according to claim 13, wherein said energy storage device has an electrical capacity of between 2 MWh and 15 MWh.

15. The arrangement according to claim 14, wherein said energy storage device has an electrical capacity of between 4 MWh and 7 MWh.

16. The arrangement according to claim 8, wherein the alternating-current grid is a medium voltage power grid with an operating voltage of between 10 kV and 30 kV.

17. The arrangement according to claim 16, wherein the alternating-current grid has an operating voltage of between 15 kV and 25 kV.

18. The arrangement according to claim 8, wherein said inverter has a nominal electrical power that corresponds at minimum to a sum of a maximum electrical primary balancing power, a maximum secondary balancing power and an electrical starting power required for starting an operation of said gas- and/or oil-CHP plant.

19. The arrangement according to claim 8, wherein said rectifier and said inverter are integrated into said combination unit.

20. The arrangement according to claim 8, wherein said battery is configured to make the balancing energy available immediately, and a powering-up period of said gas- and/or oil-CHP plant can be bypassed.
